(19) United States
(12) Patent Application Publication
(10) Pub. No.: US 2026/0148193 A1
(43) Pub. Date: May 28, 2026

(54) Computer-Implemented Method and System for Predicting Quality of Electronic Message Subject Lines

(71) Applicant: Klaviyo, Inc., Boston, MA (US)

(72) Inventors: Timothy Tadros, Boston, MA (US); Nicolas W. Asnes, Kingston, MA (US); Cayla Schuval, Boston, MA (US); Christopher Joseph Fox, Westport, CT (US); Karl Alexander Philip Ekfeldt, London (GB)

(21) Appl. No.: 18/957,272

(22) Filed: Nov. 22, 2024

(51) Int. Cl. G06Q 10/107; G06Q 30/0251

(52) U.S. Cl. CPC G06Q 10/107; G06Q 30/0255; G06Q 30/0269

(57) ABSTRACT

Computer-implemented methods and systems for generating subject lines for electronic messages for digital communication management. One method includes receiving, by a server, information related to the digital communication management, preprocessing the received information, receiving a plurality of N subject lines generated based on the preprocessed received information from a generative text engine model, ranking the N subject lines based on a trained inference model, reducing the N subject lines down to M subject lines, and displaying M subject lines to a merchant user. For an embodiment, reducing the N subject lines down to M subject lines includes, after the ranking step, filtering the N subject line to eliminate subject lines based on content, and generating similarity scores between each of the N subject lines and eliminating one or more subject lines based on a similarity with one or more other subject lines.

### FIELD OF THE DESCRIBED EMBODIMENTS

The described embodiments relate generally to intelligent electronic message management. More particularly, the described embodiments relate to systems, methods, and apparatuses for automatic generation of the subject lines.

### BACKGROUND

Electronic messages are frequently sent from online merchant users to current and prospective customers to generate sales of the merchant's products or services. The subject lines of the electronic messages can influence the success of the electronic messages. To this end, merchant users desire help crafting the optimum subject line.

Previous attempts to anticipate open rates for a subject line are described in Paulo et al., Leveraging email marketing: Using the subject line to anticipate the open rate, Expert Systems with Applications, Volume 207, 2022, 117974. However, such techniques tend to base the prediction on only the features of the current subject line when trying to predict its performance. Consequently, the same subject line will receive the same score whether Company A sends it or Company B sends it. For example, Company A may have a more playful brand whereas Company B could have a more serious brand. It follows that a subject line with lots of exclamation points and emojis would be recommended to both Company A and Company B, even if Company B may see only limited success with using such a subject line because the Company B brand is of a more serious nature.

As companies develop a unique brand voice they will engage with their audiences in different ways. A one-size fits all approach—even if sending the best electronic message overall—can still be problematic for sending electronic messages from different companies.

It is therefore desirable to have methods, apparatuses, and systems for automatic generation of the subject lines that address the above mentioned challenges.

### SUMMARY

An embodiment of the invention includes a computer-implemented method for generating subject lines for electronic messages for digital communication management. The method includes receiving, by a server, information related to the digital communication management, preprocessing, by the server, the received information, receiving a plurality of N subject lines generated based on the preprocess received information from a generative text engine model, sending a merchant user ID and the plurality of N subject lines to a trained inference model; computing, on the trained inference model, a predicted score for each of the plurality of N subject lines; ranking, on the server, the plurality of N subject lines based on the predicted scores; reducing the N subject lines down to M subject lines, and displaying M subject lines to a merchant user. For an embodiment, reducing the N subject lines down to M subject lines includes filtering the N subject line to eliminate subject lines based on for instance, sensitive content, and generating similarity scores between each of the N subject lines and eliminating one or more subject lines based on a similarity with one or more other subject lines.

Another embodiment of the invention includes a system for generating subject lines for electronic messages for digital communication management. The system includes a merchant server and a management server. For an embodiment, the management server is electronically connected to the merchant server through a network. For an embodiment, the management server is configured to receive information related to the digital communication management, preprocessing the received information, retrieve a plurality of N subject lines generated based on the preprocess received information from a generative text engine model, send a merchant user ID and the plurality of N subject lines to a trained inference model; compute, on the trained inference model, a predicted score for each of the plurality of N subject lines; rank, on the server, the plurality of N subject lines based on the predicted scores; and reduce the N subject lines down to M subject lines. For an embodiment, reducing the N subject lines down to M subject lines includes filtering the N subject line to eliminate subject lines based on content, generating similarity scores between each of the N subject lines and eliminating one or more subject lines based on a similarity with one or more other subject lines, and communicate the M subject lines to the merchant server, wherein the merchant server is configured to display the M subject lines to the merchant user.

Optionally, a fine-tuned enhancer model is applied to enhance existing content for a selected one or more of the M subject lines, and displaying M subject lines with the enhanced content to the merchant user.

In embodiments of the invention, an inference model is trained to predict success based not only on features arising from a single subject line, but also the historical range of subject lines that a merchant user has used in their emails.

In embodiments of the invention, training the inference model is based on a plurality of features derived from historical data corresponding to at least one past campaign associated with the merchant user ID and, in preferred embodiments, excludes historical data associated with another merchant user ID.

In embodiments of the invention, the features are based on recorded customer behaviors such as, for example, average open rate.

In embodiments of the invention, the features comprise textural, structural, behavioral, and derived-type features.

In embodiments of the invention, the features comprise subject lines with and subject lines without emojis.

In embodiments of the invention, the features comprise subject lines with and subject lines without personalization.

In embodiments of the invention, the features comprise subject lines categorized by length or subject lines categorized by use of punctuation.

In embodiments of the invention, the features comprise all previously sent subject lines.

In embodiments of the invention, the features comprise subject line clusters derived by categorizing each previous subject line from the historical data into one of a plurality of subject line clusters, optionally twelve (12) clusters.

In embodiments of the invention, the features comprise similarity/dissimilarity statistics and the similarity/dissimilarity statistics comprise at least one of: Average Cosine Similarity between the current subject line and a previously sent subject lines; and Weighted Cosine Similarity where each similarity score is weighted by the open rate of the previously sent subject line, such that high performing subject lines have more weight when computing the average similarity.

In embodiments of the invention, the features comprise Surprise or Average Cosine Dissimilarity (how different the subject line is from previously sent subject lines); and p25/p75 similarity—statistics to detect outliers of the average similarity/dissimilarity.

In embodiments of the invention, the training of the inference model for a subject line associated with a merchant user ID excludes historical data associated with another merchant user ID.

Other aspects and advantages of the described embodiments will become apparent from the following detailed description, taken in conjunction with the accompanying drawings, illustrating by way of example the principles of the described embodiments.

### BRIEF DESCRIPTION OF THE DRAWINGS

FIG. 1 shows a system for automatic subject line generation for electronic messages of an electronic campaign of a merchant, according to an embodiment.

FIG. 2 shows another system for automatic subject line generation for electronic messages of an electronic campaign of a merchant, according to another embodiment.

FIG. 3 shows another system for automatic subject line generation for electronic messages of an electronic campaign of a merchant, according to another embodiment.

FIG. 4 shows another system for automatic subject line generation for electronic messages of an electronic campaign of a merchant that further include training of discriminator and/or fine-tuned enhancer models, according to another embodiment.

FIG. 5 is a flow chart that includes steps of a method for automatic subject line generation for electronic messages of an electronic campaign of a merchant, according to another embodiment.

FIG. 6 is a flow chart that includes steps of a method for improvement cycles of discriminators and the text generator of an automatic subject line generation, according to an embodiment.

FIG. 7 is a flow chart that includes steps of a method for automatic subject line generation for electronic messages of an electronic campaign of a merchant, according to an embodiment.

FIG. 8 shows a more detailed system for automatic subject line generation, according to an embodiment.

FIG. 9 is a schematic diagram of another system for automatic subject line generation for electronic messages for digital communication management, according to an embodiment.

FIG. 10 is a flow chart that includes steps of a method for automatic subject line generation for electronic messages for digital communication management, according to an embodiment.

### DETAILED DESCRIPTION

The embodiments described include methods, apparatuses, and systems for generating and improving subject lines for electronic messages for digital communication management. Improved subject lines result in better performance of the digital communication management.

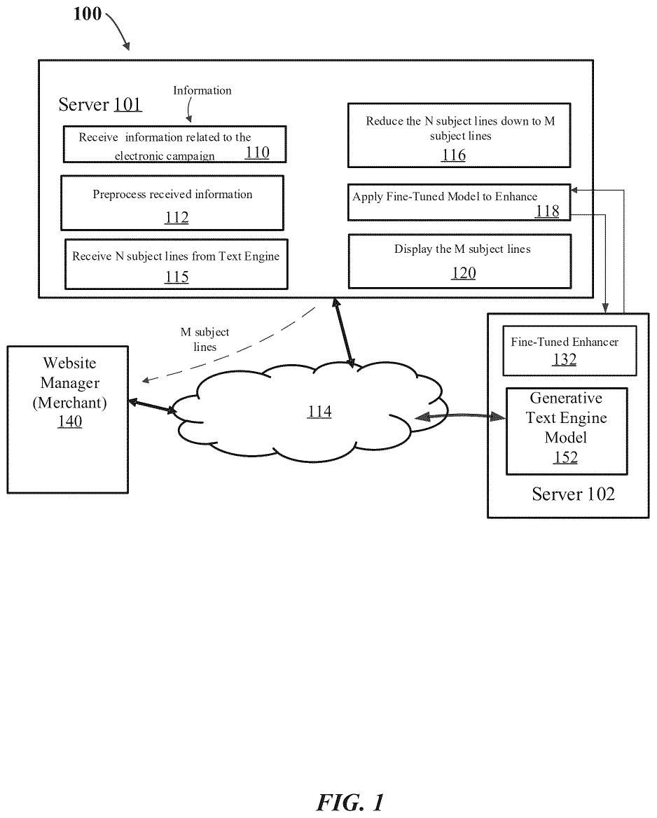

FIG. 1 shows a system 100 for automatic subject line generation for electronic messages of a digital communication management strategy (e.g., an electronic campaign) of a merchant, according to an embodiment. The system 100 includes a server 101 that is connected through an electronic network 114 to at least a merchant server 140. For an embodiment, the merchant server manages a merchant website. It is to be understood that the term “merchant” is being used liberally. That is, a merchant includes any type of business owner. For example, a merchant can include, without limitation, retail store owner, an online store owner, a teacher, a doctor, a restaurant owner, etc. Further, it is to be understood that at least some embodiments for generating subject lines for electronic messages of electronic campaigns are implemented at the server 101 which is accessed by the merchant on a client side of the server 101. Specifically, for an embodiment, the generation of the subject lines for electronic messages of electronic campaigns are performed by a UI (user interface) of the server 101.

For an embodiment, the server 101 receives 110 information related to the electronic campaign. For an embodiment, the electronic campaign provides a means for the merchant to market product and/or services of the merchant. The information includes, for example, a campaign type, a name, product, promotion, and/or brand name and/or description. Further, for at least some embodiments, the information further includes data on prior campaign information and activity undertaken by the merchant on the server 101. The server 101 may have this prior campaign information or may have access to the prior campaign information.

For an embodiment, the server 101 further operates to preprocess 112 the received information. For at least some embodiment, the preprocessing 112 includes, for example, employing formatting checks, removing keywords that could impact the performance of the text generator, and ensuring that the merchant provides sufficient information.

For an embodiment, the server 101 provides the preprocessed received information to a generative text engine model 152, and then the server 101 receives (115) a plurality of N subject lines generated based on the preprocessed received information from the generative text engine model 152. For an embodiment, the generative text engine model 152 returns text based on a given text prompt, attempting to match a pattern provided to it. For an embodiment, the generative text engine model is built on the AI (artificial intelligence) technology that is trained on large amounts of sample text such that with appropriate guidance, the generative text engine model 152 is capable of generating new text in human-readable sentences. For at least some embodiments, the generative text engine model 152 is trained further using tracked merchant and/or customer action data to improve the generative text engine model 152.

For an embodiment, the server 101 operates to reduce (116) the N subject lines down to M subject lines.

### Reducing the Number of Subject Lines

The number of N subject lines can be reduced (116) to M subject lines based on various factors, which can be based on, for example, performing formatting, length, and content checks of the subject lines.

For an embodiment, reducing the number of subject lines includes filtering the N subject lines to eliminate subject lines based on content. For an embodiment, content of subject lines that includes inappropriate and/or sensitive words are filtered out. That is, for an embodiment, subject lines that include the questionable content are eliminated.

For an embodiment, subject lines having greater than a character threshold number of characters are reduced or eliminated. For example, for an embodiment, the server 101 performs checks on the number of characters in the subject lines and only allows, for example, one subject line above 50 characters. If all the subject lines fail the character threshold number, then a new set of subject lines are generated.

For an embodiment, the post processing (processing of the subject lines after generation by the text engine model 152) further includes fixing subject lines with capitalization issues. For example, a generating subject line might include “you'll love our sale” which may be fixed to “You'll love our sale”. This additionally can be applied to subject lines enclosed in extraneous punctuation marks.

For an embodiment, reducing the number of subject lines includes generating similarity scores between each of the N subject lines and eliminating one or more subject lines based on a similarity with one or more other subject lines. That is, it can be desirable for each of the subject lines to be diverse relative to the other subject lines. Accordingly, a similarity score can be used to eliminate subject lines that are relatively similar compared to other of the subject lines. Note that it is possible to eliminate all be one unique subject line.

For an embodiment, cosine similarity scores are computed between subject lines using established vectorization methods. Namely, for an embodiment, the subject lines are embedded as vectors, and the projection of the two vectors on one another quantifies the syntactic similarities between the two subject lines. For an embodiment, when subject line pairs are determined to have high similarity scores, only one subject line of the pair is kept of the two subject lines. For an embodiment, the threshold is determined experimentally to determine what threshold of similarity works well. For an embodiment, a same similarity algorithm is run to compute pairwise similarity between each of the subject lines and the merchant-provided description, ensuring sufficient subject line difference from merchant inputs.

For an embodiment, the cosine similarity process includes taking two text strings and embedding them as vectors, meaning that the words of the text string are translated into a mathematical object that includes numbers that can be crunched (processed). For example, “My name is Josh” may be embedded as [1, 1, 1, 1, 0, 0] and “My name is John Smith” may be embedded as [1, 1, 1, 0, 1, 1]. The “cosine similarity” between these two vectors is the “distance” spanned by these two vectors, the shorter this distance, the more similar are the strings. For an embodiment, the cosine similarity threshold is selected to be ˜0.8, meaning if the cosine similarity calculated is >0.8ish, the strings are too similar and one of the strings is eliminated and not show both to the user (merchant or customer).

As previously stated, it can be desirable to include diversity across the subject lines. For an embodiment, subject lines are maintained based on pairwise similarity scores. For an embodiment, if two subject lines are within a threshold of similarity, and therefore, highly similar, one of the subject lines is excluded to avoid a case of users (merchants) being presented with a narrow range of options to choose from.

For at least some embodiments, the cosine similarity scoring is applied to not just between subject lines, but also between subject lines and the merchant providing description (text). That is, for example, it is undesirable for a merchant to ask for subject lines for a “Memorial Day Sale”, and for the subject line generator to then provide the subject line “Memorial Day Sale” or “Memorial Day Sale!” or something similar. For at least some embodiments, the similarity threshold used for determining that similarity between subject lines is different than the similarity threshold used for determining the similarity threshold between subject lines and the merchant provided description. Both of the similarity thresholds can be experimentally determined. Further, they can be adaptive from one merchant to the other.

For an embodiment, if the described methods of reducing the number of subject lines results in less than a threshold number of subject lines, the server 101 operates to resend a request for information (additional subject lines) from the generative text engine model 152.

### Fine-Tuned Enhancer Model(s) for Enhancement

For at least some embodiments, a fine-tuned enhancer model 132 can be applied (118) to enhance existing content for a selected one or more of the M subject lines. That is, the remaining M subject lines are enhanced by the fine-tuned enhancer model 132 by adding content. For an embodiment, applying (118) the fine-tuned enhancer model 132 to enhance existing content includes adding emojis to the selected one or more of the M subject lines. For an embodiment, the inclusion of emojis, for instance, is determined by training an enhancement model on historical subject line-emoji pairs, gathering an emoji selection by calling the enhancement model on a subject line, and appending the emojis to the subject line according to predetermined patterns.

For at least some embodiments, applying the fine-tuned enhancer model 132 to enhance existing content includes adding information to enhance the selected one or more of the M subject lines. For an embodiment, the process for selecting and adding the enhancements includes identifying the nature of the content presented in the subject line and appending relevant emojis based on the content, allowing merchant users the ability to automatically adjust the tone of the subject lines based on their brand tone and adding best practice keywords to improve the success rate of the subject lines. For an embodiment, adding enhancements includes altering one or more keywords of the subject line(s). For example, adding enhancement could include highlighting that merchant users should be using the word “Offer” instead of “Discount” based on previously collected data on what works best for end-recipients (for example, customers).

For at least some embodiments, the fine-tuned enhancer model 132 is applied to a randomly selected one or more of the M subject lines. For an embodiment, one of the M subject lines that make it through the post processing check is selected with equal probability for adding additional subject matter, such as, an emoji. A random selection for post process checking can be advantageous because there is no bias in subject line selection. However, at least some embodiments include at least some intelligence in the subject line selection for enhancement. For an embodiment, it may be clear that an enhancement would improve one subject line but not others, and therefore, in this case only that subject line would be selected, and not the other subject lines.

At least some embodiments include multiple fine-tuned enhancer models. For example, one fine-tuned enhancer model may be applied to subject lines, and another for subject line enhancement, such as, emojis.

For at least some embodiments, after application of the fine-tuned enhancer model, the M subject lines with enhanced existing content are displayed (120) to a merchant user at the merchant server 140.

For an embodiment, the fine-tuned enhancer model 132 and the generative text engine model 152 operate on an exemplary server 102. However, clearly the fine-tuned enhancer model 132 and the generative text engine model 152 can operate on any configurations of multiple servers.

### Tracking Merchant Actions

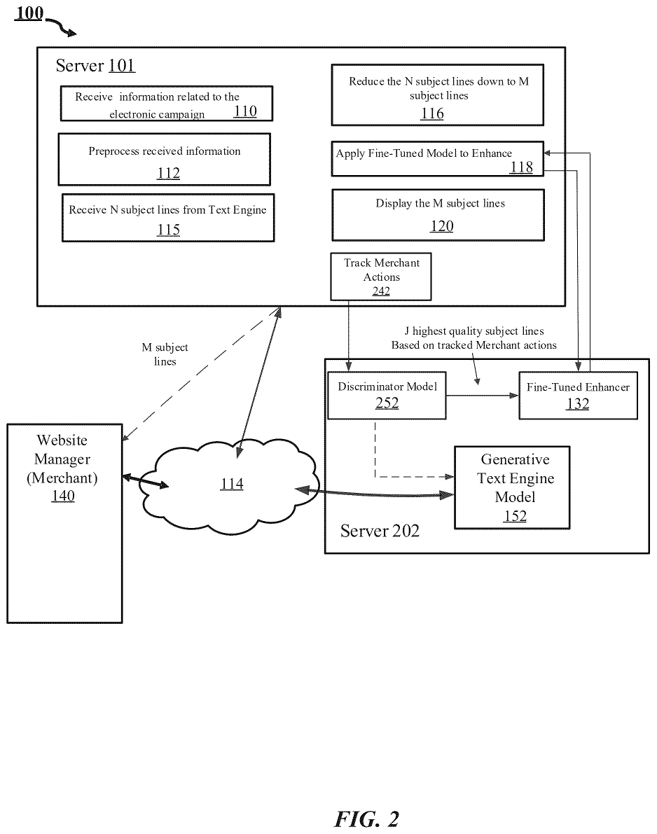

FIG. 2 shows another system for automatic subject line generation for electronic messages of an electronic campaign of a merchant, according to another embodiment. For this embodiment, the server 101 additionally tracks merchant actions 242 based on the M subject lines displayed to the merchant of the merchant server 140. For at least some embodiments, the tracking of the merchant 242 includes the tracking the merchant clicking to select a displayed subject line of the M displayed subject lines. Clicking the displayed subject line indicates an interest by the merchant in the selected subject line and indicates a level of value of the selected subject line. For an embodiment, tracking of the merchant includes tracking the merchant modifying the subject line, and submitting a final revised subject line. Modifying a selected subject line provides a level of value of the modified and submitted subject line.

For an embodiment, a discriminator model 252 operates to assign a quality rating for each of the M subject lines based on the tracked merchant actions. For an embodiment, the discriminator model 252 is provided examples of subject lines and whether or not a merchant clicked on, “liked”, or performed some other action showing interest in a generated subject line. This allows the discriminator model 252 to predict whether or not a merchant will “like” a subject line that the generator comes up with, and based on the discriminator's predicted probability that the merchant will “like” the subject line, the X subject lines with the highest X “quality ratings” can be chosen and then those X subject lines can be shown to the user (merchant), since they're the “best” of the group of subject lines.

For an embodiment, different tracked merchant actions suggest a different level of quality of each of the subject lines. Accordingly, different specific actions, and/or combinations of actions performed by the merchant on the displayed M subject lines can yield a different ranking of the subject lines.

For an embodiment, the discriminator model 252 is trained on historical tracked merchant actions on previously generated subject lines, wherein the historical merchant actions include selection, editing, and actual use of a subject line in a campaign. For an embodiment, the trained historical model is equipped to assign a quality rating to new, previously unseen M subject lines after the subject lines have been generated, allowing selection of the predicted top-performing subject lines to display to the merchant.

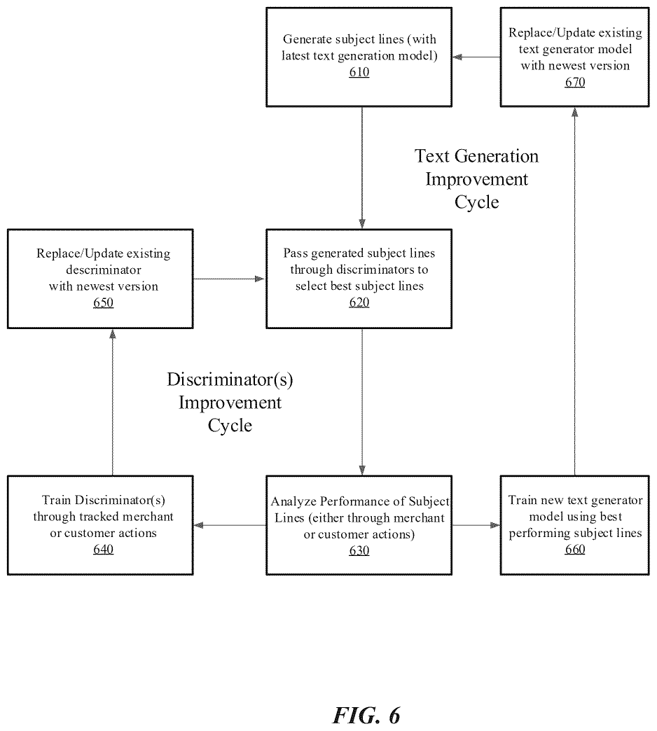

An embodiment further includes continuously updating the generative text engine model subject line generator models based on continuously tracked merchant and customer actions. The continuous updating of the generative text model is shown in FIG. 6.

For an embodiment, the fine-tuned enhancer model 132, the discriminator model 252, and the generative text engine model 152 operate on an exemplary server 202. However, clearly the fine-tuned enhancer model 132, the discriminator model 252, and the generative text engine model 152 can operate on any configurations of multiple servers.

### Tracking Customer Actions

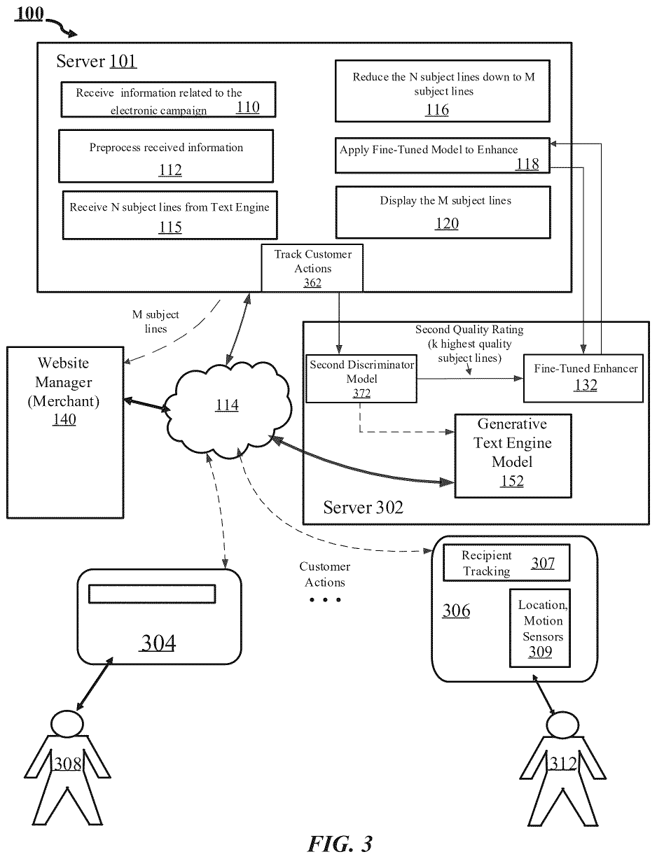

FIG. 3 shows another system for automatic subject line generation for electronic messages of an electronic campaign of a merchant, according to another embodiment. FIG. 3 further includes customer devices 304, 306 of customers 308, 312 that are electronically connected to the server 101 and the merchant server 140 through, for example, the network 114. This embodiment further includes the server 101 tracking customer actions 362 based on the subject lines displayed to one or more customers 308, 312 of the merchant of the merchant server 140.

For an embodiment, the tracking of the customers includes tracking online activity and action by the customers. For an embodiment, a customer device (such as, devices 304, 306) alone or in conjunction with the server 101, or the merchant server 140 operates to sense the customer action data. For an embodiment, the sensed and tracked customer action data includes the customer device electronically sensing a customer performing an action or activity.

While the described embodiments are directed towards sensing customer action data, it is to be understood that at least some other embodiments can additionally or alternatively include the sensing of other types of data as well. For an embodiment, the sensed data can include merchant server data, such as, daily total or new visitors on the merchant website. That is, the sensed customer action data could be replaced with, for example, data of daily total or new visitors on the merchant website.

The customer action data may be tracked (counted) over various possible time periods (such as, by the second, minute, hour, day, week, or month) and may include one or more of customers (308, 312) being active on the website of the merchant server 140, a sent email bouncing, a customer canceled order, a customer starting a checkout, a customer clicking (selecting) an email, a customer opening email, a customer placing order, a customer receiving email, a customer refunding an order, a customer unsubscribing, a customer viewing a product, a customer adding to a list (a list in the marketing automation platform of the server 101 account), and/or a customer adding an item to their cart.

It is to be understood, however, that there are very few limitations on what event types (customer actions) can be published (provided) to a marketing automation platform of the server 101. Website managers (such as website manager of merchant server 140) can implement their own events (sensed customer actions) that make sense for their business and simply send those events over to the marketing automation platform of the server 101.

Further, as will be described, implementations of the devices 304, 306 that include mobile devices can additionally or alternatively include additional types of sensed customer actions. Such sensed customer action can include sensing a physical customer visit and/or purchase. That is, the sensing of the customer action can include sensing the customer visiting a physical location of the merchant, and/or the customer purchasing a product or service of the merchant at a physical store location of the merchant. Further, the sensed customer actions can include combinations or sequences of customer actions. For an embodiment, sensed customer actions are weighted based on the sensed customer actions. For an embodiment, only sensed customer actions having a weight, or a combination of weights that exceed a customer action threshold are considered a customer action for the purposes of detecting customer actions.

For an embodiment, the location monitoring of the mobile device of the customer is used to identify business locations visited by the recipient after receiving the campaign. Different businesses can be rated, wherein particular businesses yield a higher customer action score, and other particular businesses yield a lower engagement score. The customer action score of each business can be adaptively adjusted based on the electronic campaign of the merchant and can be adjusted based on other businesses visited by the recipient. For an embodiment, patterns of location visits by the recipient can be used to influence the level of customer action.

For an embodiment, motion of the recipient is tracked by location and motion sensors 309, and can be used to influence the level of customer action. Certain actions (motions) of the recipient may indicate different levels of customer action. For an embodiment, the computing devices 304, 306 may include a mobile phone, a smart watch, or a headset. Motion of the recipient can include tracking hand motions, direction of eyesight, and/or orientations of the recipient. Accordingly, whether the recipient is in a physical location of a product of the merchant can be determined. Further, how long the recipient holds or looks at a specific product of the merchant can be determined. Further, whether the recipient interacts with another recipient can be determined. All the sensed/tracked locations and motions of the customer can be included within a score of the customer action. Again, a score that exceeds a score threshold can be deemed a customer action. The actions and locations of the customer can be tracked 307 allowing patterns in the customer behavior to be determined. As described, sequences of behaviors by the customer can be ranked for determining of a score which is used for determining whether a customer action has occurred.

Further, for an embodiment, different businesses physically visited can be rated, wherein particular businesses yield a higher success score and other particular businesses yield a lower success score. The success score of each business can be adaptively adjusted based on campaigns and can be adjusted based on other businesses visited by the customer. For an embodiment, patterns of location visits by the customer can be used to influence the level of success. That is, for example, visiting a location of a business can be rated higher or lower based on a previous business visited by the customer.

As previously described, the customer tracking can include monitoring of web browsing of the customer. Online action and activity of the customer can influence the success score. Links accessed by the customer can be tracked. Websites visited by the customer can be tracked. Online purchases of the customer can be tracked. Each of the online web browsing of the customer can influence the success score of the customer actions.

For an embodiment, relationships between different customers are determined. For example, web tracking can determine online relationships between customers. Further, for an embodiment, a real physical relationship between customers can be established by tracking the locations of the different customers. Two customers may be identified as living together based on location tracking. Further, commonalities of recipients can be determined by identifying common locations, or common types of locations between the different customers. The influence one customer has on another customer can be measured and the influence can add or subtract from the success score.

For an embodiment, a level of customer action can be adaptively adjusted for each customer based on actions of an associated customer. An action by a related or common type of customer can influence how much an action by a customer influences the engagement determination or influences a success determination.

As previously described, the success determination of the described customer actions can be scored, and a score exceeding a score threshold can qualify as a customer action which is tracked.

For an embodiment, a second discriminator model 372 assigns a second quality rating for each of the subject lines displayed to the one or more customers based on the tracked customer actions. For an embodiment, the rankings of the customer actions influence the second quality rating of each of the subject lines. For an embodiment, the second discriminator model 372 is trained on historical tracked customer actions on previously generated subject lines, including opens of and clicks in email campaigns with a certain subject line. With this training the model assigns a quality rating to new, previously unseen M subject lines after they have been generated, allowing selection of the predicted top-performing subject lines to display to the merchant.

At least some embodiments include supplementing data used to train the fine-tuned enhancer model 132 with K highest quality rating subject lines as determined by actions of the one or more customers.

At least some embodiments further include continuously updating the generative text engine model 152 based on continuously generated second quality ratings as determined by the second discriminator model 372. A process for enhancing the operation of the generative text engine model 152 is shown in FIG. 6.

For at least some embodiment, assigning by the second quality rating by the second discriminator model comprises receiving, by the merchant server, customer actions for electronic messages having different subject lines and the same message content. An embodiment includes a form of A/B testing. For an embodiment, when it comes to forms or messages of an electronic campaign, the testing includes the creation of an “all things being equal” experiment, with one single difference that is hypothesized to generate better performance. For an embodiment, in the case of subject lines, a user (merchant) may choose to A/B test two subject lines, one from the generator, and one that the user (merchant) creates themselves, wherein the messages or forms are identical, but the subject lines are different. Further, for an embodiment, two generated subject lines can be A/B tested against each other, wherein the subject lines of two electronic messages are different, but the content of the electronic messages are identical. This allows for testing of the quality of the subject lines against each other which can be used to further advance the quality ratings of the different generated subject lines. For the purpose of assigning quality ratings through the discriminator that can predict best merchant reception, and through the second discriminator that can predict best customer reception, a combination of the two, rather than a competition between the two, the quality ratings assigned by each of these two discriminators can be utilized.

For an embodiment, the fine-tuned enhancer model 132, both discriminator models 252 and 372, and the generative text engine model 152 operate on an exemplary server 302. However, clearly the fine-tuned enhancer model 132, both of the discriminator models 252 and 372 and the generative text engine model 152 can operate on any configurations of multiple servers.

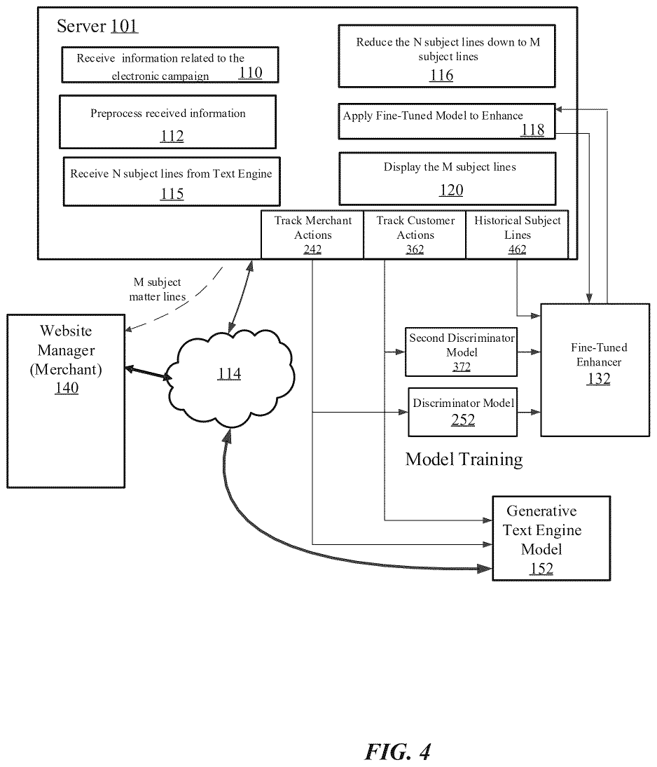

FIG. 4 shows another system for automatic subject line generation for electronic messages of an electronic campaign of a merchant that further include training of discriminator and/or fine-tuned enhancer models, according to another embodiment. For an embodiment, the first discriminator model 252 and the second discriminator model 372 both simultaneously provide highest quality subject lines to the fine-tuned enhancer model 132. For an embodiment, discriminator models can be used together to create a conclusive quality rating by for example creating a weighted sum of the outputs of the two models. For an embodiment, one of the discriminator models has a greater influence on the quality rating than the other of the discriminator models. For example, when a quality rating of one of the discriminator models suggests a very high quality (greater than a predetermined threshold) then that discriminator model provides the dominant quality rating. For example, the actions of the merchant user may indicate one subject line to have a high quality. However, the customer action may indicate that one other subject line is substantially (greater than the predetermined threshold). For an embodiment, the customer actions provide a better subject line quality indication than the merchant actions. Accordingly, in this case, the second discriminator model has a greater influence on the quality of the subject lines than the discriminator model.

For an embodiment, the discriminator 252 and the second discriminator 372 are combined to form a single discriminator model that is trained using data consists of both merchant and customer actions.

FIG. 4 further includes historical subject lines 462. This includes the tracking of past subject lines and the successes of the past subject lines. These successes can be used to improve the generation of future subject lines.

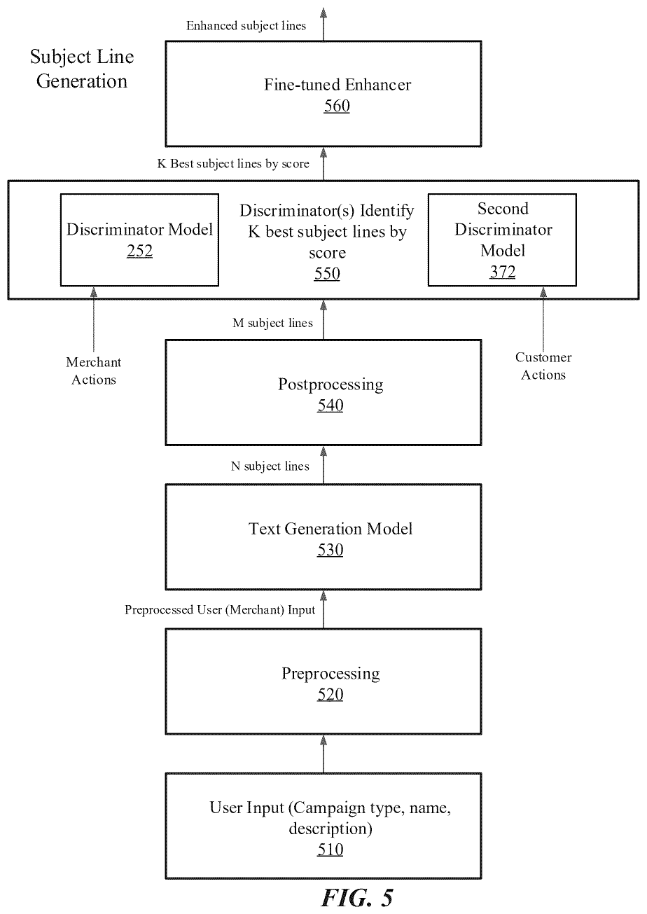

FIG. 5 is a flow chart that includes steps of a method for automatic subject line generation for electronic messages of an electronic campaign of a merchant, according to another embodiment. As shown, a first step 510 includes receiving the merchant user inputs related to an electronic campaign. As previously described, the merchant user inputs include, for example, a campaign type, name, description, etc. A second step 520 includes preprocessing the merchant user inputs. As previously described, the preprocessing can include, for example, employing formatting checks, removing keywords that could impact the performance of the text generator, and ensuring that the merchant provides sufficient information. A third step 530 includes providing the preprocessed merchant input information to a text generation model which generates N subject lines that could be used by the merchant for an electronic campaign. A fourth step 540 includes postprocessing the N subject lines to reduce the number of subject lines down to M subject lines. The number of subject lines can be reduced by one or more of the many described embodiments for reducing the number of subject lines. A fifth step 550 includes identifying the K best subject lines of the M subject lines. For at least some embodiments, the K best subject lines are identified based on actions of merchant users and/or customers of the merchant. The merchant user action can be provided to a discriminator model, and the customer actions can be provided to a second discriminator model. The discriminators identify the best subject lines by sensing one or more of the merchant user actions and/or the customer actions. The sensing can take any of one or more of the many described merchant users and/or customer actions. For at least some embodiments, the actions include combinations and/or sequences of action for determining the quality of each subject line. A sixth step 560 includes enhancing the K higher quality rating subject lines with additional or modified contents. The modified K highest quality subject lines can be provided back to the generative text engine model to improve future subject line generation.

FIG. 6 is a flow chart that includes steps of a flow chart of a method for improvement cycles of discriminators and the text generator of an automatic subject line generation, according to an embodiment. A first step 610 includes generating the M subject lines with the latest text generation model. As previously described, the highest quality subject lines of a prior electronic campaign are feedback to the text generation model to allow for improvement of future subject line generation. A second step 620 includes passing the generated subject lines through one or more of the discriminator model or the second discriminator model for selecting the best quality subject lines of the generated subject lines. A third step 630 includes analyzing the performance of the best quality subject lines based on actions of the merchant user and/or customer users of the electronic campaign. A fourth step 640 includes training the discriminator model and the second discriminator model based on the merchant user and the customer user actions. A fifth step 650 includes replacing/updating the discriminator model and/or the second discriminator model based on the tracked merchant user and/or customer user actions. The updating/replacing of the discriminator models is performed by a discriminator(s) improvement cycle which can be performed for every electronic campaign.

An embodiment further includes a text generator model improvement cycle. A sixth step 660 training the text generator model using the best performing subject lines as determined by the actions of the merchant users and/or the customer users. A seventh step 670 includes replacing/updating/modifying the existing text generation model with a new version.

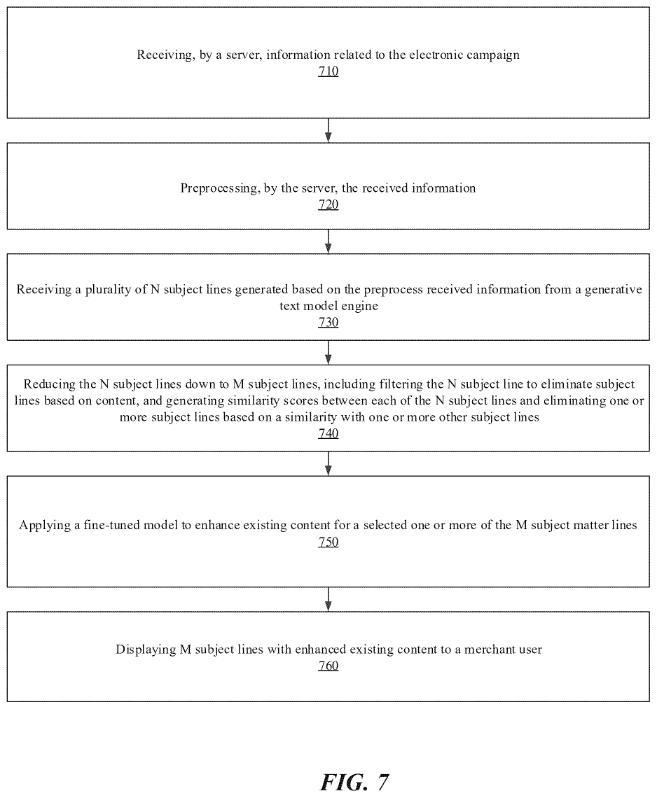

FIG. 7 is a flow chart that includes steps of a method for automatic subject line generation for electronic messages of electronic campaigns, according to an embodiment. A first step 710 includes receiving, by a server, information related to the electronic campaign. A second step 720 includes preprocessing, by the server, the received information. A third step 730 includes receiving a plurality of N subject lines generated based on the preprocess received information from a generative text engine model. A fourth step 740 includes reducing the N subject lines down to M subject lines, including filtering the N subject line to eliminate subject lines based on content, and generating similarity scores between each of the N subject lines and eliminating one or more subject lines based on a similarity with one or more other subject lines. A fifth step 750 includes applying a fine-tuned enhancer model to enhance existing content for a selected one or more of the M subject lines. A sixth step 760 includes displaying M subject lines with enhanced existing content to a merchant user.

As previously described, for an embodiment, reducing the N subject lines down to M subject lines, further comprises eliminating subject lines that have greater than a character threshold number of characters.

As previously described, for an embodiment, filtering the N subject line to eliminate subject lines based on content includes eliminating subject lines that include inappropriate and politically sensitive words.

As previously described, for an embodiment, generating similarity scores between each of the N subject lines and eliminating one or more subject lines based on a similarity with one or more other subject lines comprises computing cosine similarities between the subject lines. As previously described, for an embodiment, generating similarity scores between each of the N subject lines and eliminating one or more subject lines based on a similarity with one or more other subject lines comprises prioritizing diversity across displayed subject lines based on pairwise similarity scores.

As previously described, for an embodiment, applying the fine-tuned enhancer model to enhance existing content includes adding emojis to the selected one or more of the M subject lines. For an embodiment, enhancing the existing content is based on collected information from subject lines of past high-performing electronic campaigns and adjusting content of the subject lines to reflect a brand tone of the merchant user based on content and success of past high-performing electronic campaigns and existing website content. For an embodiment, applying a fine-tuned enhancer model to enhance existing content includes adjusting or supplementing to the selected one or more of the M subject lines. For an embodiment, the fine-tuned enhancer model is applied to a selected one or more of the M subject lines.

For an embodiment, the server is electronically connected to a merchant server. Further, the server tracks merchant actions at the merchant server based on the M subject lines displayed. A discriminator model assigns a quality rating for each of the M subject lines based on the tracked merchant actions, and supplements data used to train the fine-tuned enhancer model with J highest quality rating subject lines.

As previously described, at least some embodiments include continuously updating the generative text engine model based on continuously generated quality ratings.

As previously described, for an embodiment, the server is electronically connected to a merchant server, and to a plurality of customer devices. Further, the server, tracks customer actions of customers at the customer devices based on the subject lines displayed to one or more customers of a merchant of the merchant server. A second discriminator model assigns a second quality rating for each of the subject lines displayed to the one or more customers based on the tracked customer action, and supplements data used to train the fine-tuned enhancer model with K highest quality rating subject lines as determined by actions of the one or more customers. For an embodiment, tracking the customer actions comprises sensing the customer actions at the customer devices. For an embodiment, sensing the customer action comprises sensing online action of the one or more customers. For an embodiment, sensing the customer action comprises sensing physical motion of the customer devices of the one or more customers. At least some embodiments further include continuously updating the generative text engine model based on continuously generated second quality ratings. For an embodiment, assigning by the second quality rating by the second discriminator model comprises receiving, by the server, customer actions for electronic messages having different subject lines and a same message content.

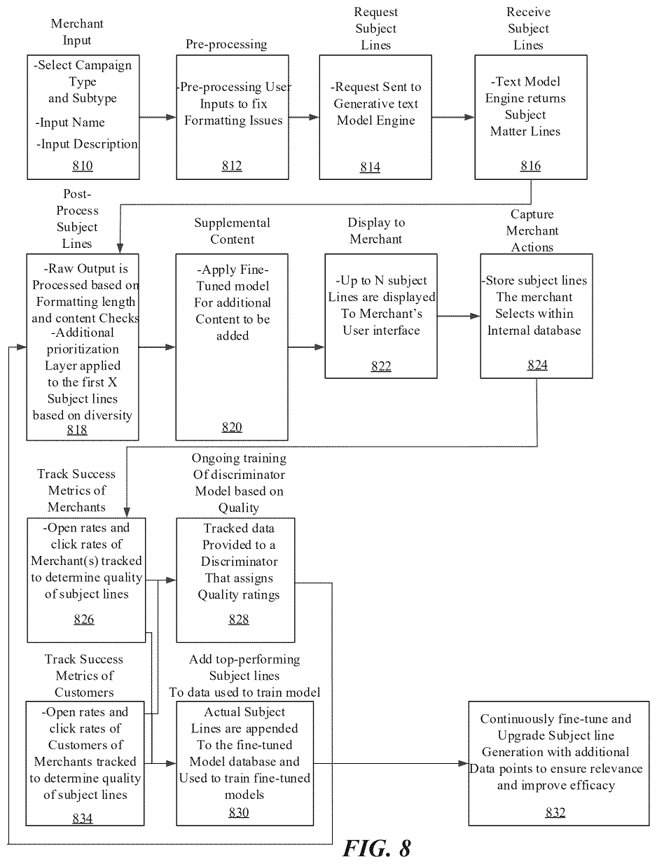

FIG. 8 is a flow chart that includes steps of another method for automatic subject line generation for electronic messages of an electronic campaign of a merchant, according to another embodiment. A step 810 includes receiving inputs from the merchant, such as, a campaign type and subtype selection. This step may be similar to step 710 of FIG. 7. A step 812 includes pre-processing user (merchant) inputs to fix any formatting issues. This step may be similar to step 720 of FIG. 7. Steps 814 and 816 include requesting and receiving subject lines from a generative text engine model. These steps may be similar as step 730 of FIG. 7. A step 818 includes post-processing of the subject lines, including formatting and content checks. This step may be similar to step 740 of FIG. 7. A step 820 includes applying a fine-tuned enhancer model to add and enhance content of the subject lines. This step may be similar to step 750 of FIG. 7. A step 822 includes displaying up to N subject lines to a user interface of the merchant. This step may be similar to step 750 of FIG. 7. A step 824 includes storing the subject lines in an internal database which can then be selected by the merchant user.

Once displayed to the merchant, the success and quality of the presented subject lines is tracked and determined. Based on the tracked success and quality of the subject lines used for electronic messaging with the merchant, a discriminator model is continuously trained. Further, for an embodiment, based on the tracked success and quality of the subject lines used for electronic messaging with customers of the merchant, a second discriminator model is continuously trained.

A step 826 includes tracking success or quality of the subject lines based on merchant actions, such as, selections, edits, and use in campaigns of generated subject lines. A step 828 includes ongoing training of the discriminator model (such as, discriminator model 252) based on the tracked successes of the subject lines.

A step 830 includes adding top-performing subject lines to data used to train the text generator model as previously shown in FIG. 6.

A step 832 includes continuously fine-tuning and upgrading the subject line generation with additional data to ensure relevance and efficacy of the future generated subject lines. By expanding the number of subject lines processed by the fine-tuned enhancer aided text generator model, the text generation model should be expected to produce text that will more closely follow patterns similar to real-life subject lines.

A step 834 includes tracking success or quality of the subject lines based on actions of customers of the merchant, such as, open and click rates of messages that include the subject lines. As previously described, the merchant actions and the customer actions are used to evaluate the quality of the subject lines presented to the merchant and/or the customer. The describe discriminators and the generative text engine model are trained based on the quality subject line quality determinations. The trained models provide better recommendations in the future, thereby improving the subject line generation over time.

Further, for at least some embodiments, the steps 828 and 830 further account for subject line success based on tracked success based on actions of the customers of the merchants.

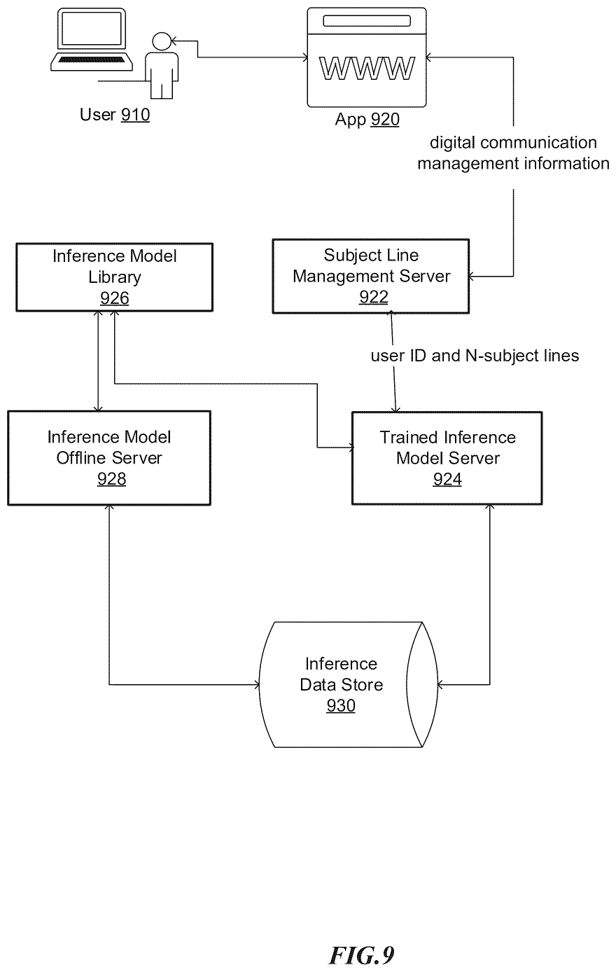

FIG. 9 shows another system for automatic subject line generation for electronic messages for a digital communication strategy (e.g., an electronic campaign) of a merchant user, according to an embodiment of the invention.

In the embodiment shown in FIG. 9, a user 910 (e.g., merchant user) enters information through an application interface 920 that is associated with the backend subject line management server 922. Exemplary information includes information relating to the merchant user's digital communication management or strategy, electronic campaign information, or digital marketing information. Such information can include, without limitation, the merchant user ID, campaign ID, and contextual information such as type/class of email and description of the subject matter of the email. Examples of types or classes of email include, without limitation, holiday sale, discount, and product launch.

The subject line management server 922 receives the information and is programmed and operable to send a prompt to a generative text engine model, discussed above, to obtain a plurality of candidate subject lines (e.g., a plurality of N subject lines) based on the information. In embodiments, 6-12 subject lines are generated.

Additionally, the subject line management server 922 automatically sends a prompt to an inference model server 924. In embodiments, the prompt includes the N subject lines and the merchant user ID or name. As discussed herein, the inference model server 924 includes a trained inference model that is operable to make a call to the inference data store 930. The request to the inference data store 930 includes the merchant user ID.

The inference data store 930 returns all the computed values corresponding to the features used to train the model, for the particular merchant's history of subject lines.

The online inference model 924 concatenates all the features related to the subject line and computes predicted scores for each of the N generated subject lines.

The subject line management server then ranks all the subject lines based on their predicted scores.

In embodiments, the subject line management server 922 further applies a filtering function to reduce the number to M subject lines, as described above. In embodiments, similar subject lines are excluded. In embodiments, M is less than or equal to 5.

The App 920 shows or displays the optimized ranking of M subject lines to the user 910.

FIG. 9 also shows inference model library 926 and inference model offline server 928.

The inference model library 926 is a library for storing and providing pre-written code to the trained online inference model 924 server and offline inference model server 928. Examples of modules in the library include, without limitation, Emoji counters, Sentence Transformer embeddings, and python string utilities.

The inference model offline server 928 is programmed and operable to pull campaign data from other databases, and to compute the values for features. For example, historical campaign data can be pulled periodically from a number of different databases such as, without limitation, cloud-based data warehousing platform Snowflake and cloud-based object storage AWS S3 by Amazon. The inference model offline server 928 also computes the values of the features for each of the companies/merchants based on the historical campaign data. The computed values for the features for each of the companies is provided to the online inference datastore 930 for use by the trained inference model server 924.

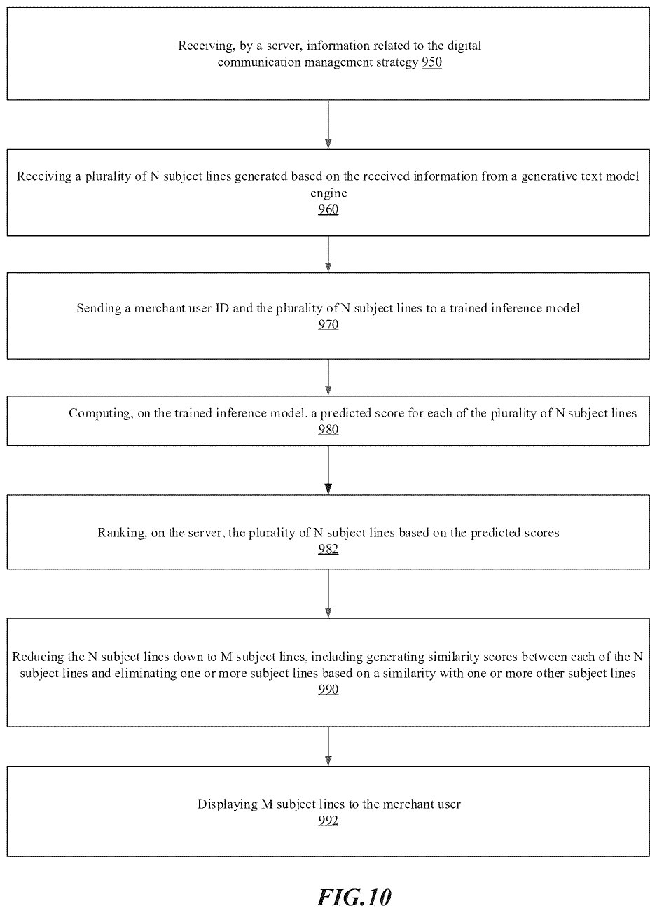

FIG. 10 is a flow chart that includes steps of a method for automatic subject line generation for electronic messages of a digital communication management strategy of a merchant, according to an embodiment.

Step 950 states receiving, by a server, information related to the digital communication management strategy. As discussed herein the server receives various types of information from the merchant user. Examples of information include structural information such as the merchant user's ID, campaign ID as well as textural information in the description of the campaign such as the type of sale desired (e.g., holiday sale).

Step 960 states receiving a plurality of N subject lines generated by a generative text model engine and based on sending the text model engine the context related information, and in some embodiments, excluding the user's ID. This step may be performed using LLM technologies to generate a plurality of N subject lines where the integer ‘N’ may vary and, in some embodiments, is between 6 and 12. An example of a suitable LLM technology is GPT-4 by OpenAI Inc. (San Francisco, CA).

Step 970 states to send the merchant user ID and the plurality of N subject lines to a trained inference model. With reference to FIG. 9, the subject line management server 922 sends this information to the trained inference model server 924. As described herein, the trained inference model is trained using certain features the inventors have found to be of consequence. The training data set includes all historical campaign data for the specific user merchant of all sent email subject lines and the customer behaviors including, e.g., email open rate. In embodiments, the data set excludes historical data of other merchant user's regardless of whether the subject lines were identical.

Step 980 states computing, on the trained inference model 924, a predicted score for each of the plurality of N subject lines. In embodiments, the trained inference model is trained on historical campaign data to receive a subject line and user merchant ID, and output a quality score representing success or likelihood the recipient shall open the electronic message. Because the inference model is trained on customized merchant user-specific datasets, the scores are user merchant dependent. Consequently, if the identical set of N subject lines is submitted to the trained inference model 924 for two different merchant users, the inference model is capable and may provide different scores for the subject lines depending on the user merchant.

Step 982 states ranking, on the management server 922, the plurality of N subject lines based on the predicted scores.

Step 990 states reducing the N subject lines down to M subject lines, including generating similarity scores between each of the N subject lines and eliminating one or more subject lines based on a similarity with one or more other subject lines. As described above, the server 101, 922 is operable to filter the ranked list of N subject lines to M subject lines.

Step 992 states displaying M subject lines to the merchant user. This step may be performed by an API 920 presenting the information to the user via their computing device 910.

### Inference Model Training

In embodiments of the invention, a method for training comprises one of more of the steps described herein.

Data Collection. In embodiments, a first step in the training process is to collect relevant historical data that can be used to predict future subject line performance. In embodiments, this step is performed by gathering data on historical campaigns from various databases for multiple merchant users. Historical data can be collected from, e.g., the merchant's email service providers, online store platforms, as well as third party marketing service provider services, such as but not limited to Shopify, WooCommerce. and MailChimp. In embodiments, the data is collected and is arranged in a csv file in rows by merchant user including columns for the merchant user ID, email subject line, and open rate. In some embodiments, at least 500 sent emails for each merchant user are collected, depending on how much historical data is present for each merchant.

Data Processing. In embodiments, the data in the data set is preprocessed. This can include: removing special characters and stop words; and removing non-English subject lines Feature Extraction. In embodiments, the data is transformed into numerical features that can be fed into the machine learning model. The inventors have found useful a wide variety of features that are extracted to be fed into the model, discussed herein.

### A. User-agnostic Features for Current Subject Line

In embodiments, the text of each subject line is vectorized. In embodiments, the text of the current subject line is vectorized into a 784-dimensional embedding. A non-limiting exemplary technique for creating the embedding is computing embeddings with transformer models.

### B. User-specific Features for Historical Subject Lines

In embodiments, a method computes for each specific merchant user (e.g., Company A, B, C, etc.) various statistics including average open rates, standard deviation, and number of campaigns. These statistics are computed and aggregated over campaigns where the associated subject line included one of several attributes: (a) subject lines with and subject lines without emojis; (b) subject lines with and subject lines without personalization (e.g., user name); (c) subject lines categorized by length (short, medium, long based on number of characters in the subject line); (d) subject lines categorized by use of punctuation (low, medium, high based on number of punctuation marks); and (e) a catch-all of all previously sent subject lines

### C. Clustering

In embodiments, a method builds a clustering algorithm based on all historical subject lines for each specific merchant user. In embodiments, each subject line is grouped into one of 12 clusters or categories. In embodiments, the clusters are predetermined based on human-interpretation of these clusters. Examples of categories or clusters include, without limitation: (a) a particular type of holiday advertisement (“'Tis the Season for ... ”), (b) a message of urgency (“Sale Ends Soon”), and (c) a discount (“15% off”), etc.

Statistics are computed over the clusters. Exemplary statistics for each cluster include: average open rates, standard deviation, and number of campaigns computed and aggregated over all campaigns where the subject line belonged to a specific cluster.

### D. Overlap

In embodiments, a method computes the overlap between the current subject line (the subject line we are interested in including or filtering out in the future) and historical subject lines. In embodiments, subject lines were embedded into a vector (e.g., 784-dimensional space) using a Natural Language Processing technologies such as BERT LLM embeddings.

After these embeddings are computed for both the current subject line and all historical subject lines, various derived features are computed relating to: (a) how similar is this subject line to previously sent subject lines and (b) how surprising/dissimilar is this subject line to previously sent subject lines. Without intending to be bound to theory, similar subject lines perform similar to one another and also, sometimes, other subject lines provide a surprise or “shock factor” that increases engagement once in a while. In embodiments, the similarity-measured derived features include: Average Cosine Similarity between the current subject line and previously sent subject lines; Weighted Cosine Similarity where each similarity score is weighted by the open rate of the previously sent subject line, such that high performing subject lines have more weight when computing the average similarity; “surprise” or Average Cosine Dissimilarity—i.e., how different the subject line is from previously sent subject lines; and p25/p75 similarity—statistics to detect outliers of the average similarity/dissimilarity

In embodiments, feature computation creates a multi-dimensional representation of a subject line with statistics related to the characteristics of the current subject line as well as characteristics of previously sent subject lines for a company and characteristics of overlap between the current subject line and previously sent subject lines. In embodiments, the feature computation creates a dimensional representation greater than 768, sometimes greater than 784, and in some embodiments, at least 863 dimensions for each subject line corresponding to textural, linguistic (sentiment score such as emotional tone), structural (e.g., metadata including the user ID, campaign ID, etc.), behavior (e.g., open rate, etc.), derived (e.g., clustering, predetermined categories), and statistical features (e.g., means, standard deviation, R-squared, etc.).

Model Selection. In embodiments of the invention, the inference model to be trained is a machine learning model such as, for example, a regression model, Support Vector Machines (SVM), Neural Networks, and Recurrent Neural Networks (RNNs) or Transformers (like BERT). In a preferred embodiment, the inference model is a Gradient-Boosted Tree model.

Training the Model. In embodiments, training comprises splitting the data set into training and validation sets. In embodiments, the data set is split into a single training set and a separate validation set. The model is trained using the training set of data and the above-described features and open rates as inputs. The model outputs the predicted score of the subject line. Tuning is performed using the validation set where the following hyperparameters were set: the number of historical campaigns to include in feature computation (e.g., 3, 6, or 12 months of data), which transformer model architecture to compute subject line embeddings (e.g., BERT or GPT), number of trees to use in the model (e.g., 300 to 1000 trees), and the learning rate for the model (e.g., 0.2, 0.3, and 0.5).

In embodiments, the preferred hyperparameters were as follows: Learning rate: 0.2; Number of trees: 1000; Historical campaign data: 3 months; and Transformer model architecture: BERT.

Evaluation. After the model is trained, we evaluate its performance using a metric such as Mean Squared Error (MSE), Mean Absolute Error (MAE), and in preferred embodiments, R-squared value to evaluate the goodness of the fit of the model.

By incorporating the above-described merchant user-specific features, the R-squared value increased from 13% to 30.3%.

Fine-Tuning. In embodiments, after evaluation, the model is optionally adjusted based on evaluation results. For embodiments, the hyperparameters of the model are further adjusted by including more data in the set of historical features used and using more advanced LLM embedding transformer models.

Deployment. In embodiments, the model is deployed for online or live use for evaluating new subject lines. This step can be carried out by deploying the model at server 924. Code versions of the model may be stored in the model library 926 or another location. Optionally, CI/CD implementation is provided to update and deploy the inference model when any changes are made to the offline model 928.

Once deployed, the trained inference model is available to return ranked subject lines as described herein.

Although specific embodiments have been described and illustrated, the embodiments are not to be limited to the specific forms or arrangements of parts so described and illustrated. The described embodiments are to only be limited by the claims.

For example, aspects of the invention are applicable to SMS. SMS messages can be generated and ranked according to the steps described above for subject lines, except for the entire SMS message.

Additionally, embodiments of the invention can include building an inference model for ranking the subject lines based on historical recipient data instead of the merchant user (namely, sender) data. Indeed, some recipients might tend to engage with “serious”-type subject lines while others may prefer more “silly” content. In embodiments, a method computes features for the recipient that is receiving the Campaign (what kind of subject lines have they responded to in the past, what subject lines have they not engaged with, etc.) to recommend personalized subject lines based on the set of recipients of the marketing content.

Additionally, embodiments of the invention can include predicting scores and ranking and providing, not only subject line content, but other types of content. Examples of other types of content include, without limitation, text, images, links, and formatting. Indeed, the steps described herein can be utilized to predict the quality of various types of campaign content, customized for the specific merchant (or company) based on its historical data.

1. A computer-implemented method of generating feature vectors for subject lines for electronic messages for digital communication management for a merchant user, comprising:
receiving by a server, information related to the digital communication management for the merchant user;
preprocessing, by the server, the received information;
preparing a prompt based on the preprocessed received information;
sending the prompt to a generative text engine model, wherein the generative text engine model is a trained AI-based model operable to generate new text based on a text prompt;
receiving a plurality of N subject lines generated based on the prompt from the generative text engine model;
preparing a request including the N subject lines and an ID of the merchant user;
preparing a merchant user ID-specific data set including historical data corresponding to at least one past digital communication strategy associated with the merchant user ID and excluding historical data associated with another merchant user ID;
training an inference model using the merchant user ID-specific data set and a plurality of features derived from the historical data;
sending the request containing the merchant user ID and the plurality of N subject lines to the trained inference model;
responsive to sending the request, making a call to a data store to retrieve precomputed values corresponding to the features and specific to the merchant user ID;
concatenating the retrieved precomputed values with a transformer embedding of the corresponding subject line to form a feature vector for each of the plurality of N subject lines specific to the merchant user ID; and
determining, by the inference model, a predicted score for each of the plurality of N subject lines based on the feature vector of the corresponding subject line;
ranking, on the server, the plurality of N subject lines based on the predicted scores;
reducing the N subject lines down to M subject lines, comprising generating similarity scores between the transformer embeddings of each of the N subject lines and eliminating one or more subject lines based on a similarity with one or more other subject lines; and
displaying the M subject lines to the merchant user.

2. The method of claim 1, wherein generating similarity scores between each of the N subject lines and eliminating one or more subject lines based on a similarity with one or more other subject lines comprises computing cosine similarities between the transformer embeddings.

3. The method of claim 1, further comprising applying a fine-tuned enhancer model to enhance existing content for a selected one or more of the M subject lines, wherein applying a fine-tuned enhancer model to enhance existing content includes adjusting or supplementing to the selected one or more of the M subject lines.

4. The method of claim 1, wherein the server is electronically connected to a merchant server, and to a plurality of customer devices, and further comprising:
tracking, by the server, customer actions of customers at the plurality of customer devices based on the subject lines displayed to one or more customers of a merchant of the merchant server;
assigning, by a second discriminator model, a second quality rating for each of the subject lines displayed to the one or more customers based on the tracked customer actions; and
supplementing data used to train the fine-tuned enhancer model with K highest quality rating subject lines as determined by actions of the one or more customers.

5. The method of claim 4, wherein tracking the customer actions comprises sensing the customer actions at the customer devices.

6. The method of claim 5, wherein the sensing the customer actions comprises sensing online action of the one or more customers.

7. The method of claim 4, further comprising continuously updating the generative text engine model based on continuously generated second quality ratings.

8. The method of claim 4, wherein assigning by the second quality rating by the second discriminator model comprises receiving, by the server, customer actions for electronic messages having different subject lines and a same message content.

9. (canceled)

10. The method of claim 1, wherein the features are based on recorded customer actions.

11. The method of claim 10, wherein the customer actions include average open rate.

12. The method of claim 10, wherein the features comprise textural, structural, behavioral, and derived-type features.

13. The method of claim 10, wherein the features comprise subject lines with and subject lines without emojis; subject lines with and subject lines without personalization.

14. The method of claim 10, wherein the features comprise subject lines categorized by length or subject lines categorized by use of punctuation.

15. The method of claim 10, wherein the features comprise all previously sent subject lines.

16. The method of claim 10, wherein the features comprise subject line clusters derived by categorizing each previous subject line from the historical data into one of a plurality of subject line clusters.

17. The method of claim 10, wherein the features comprise similarity/dissimilarity statistics wherein the similarity/dissimilarity statistics comprise at least one of: Average Cosine Similarity between the current subject line and a previously sent subject lines; and Weighted Cosine Similarity where each similarity score is weighted by the open rate of the previously sent subject line.

18. The method of claim 10, wherein the features comprise Surprise or Average Cosine Dissimilarity; and p25/p75 similarity.

19. A system for generating feature vectors for subject lines for electronic messages for digital communication management for a merchant user, comprising:
a merchant user application interface;
an inference data store comprising precomputed values specific to merchant user IDs and based on a plurality of features derived from historical data for the merchant users;
a subject line management server electronically connected to the merchant user application interface through a network, the subject line management server configured to:
receive information related to the digital communication management from the merchant user server;
preprocess the received information;
prepare a prompt based on the received information;
retrieve a plurality of N subject lines generated based on the prompt from a generative text engine model; wherein the generative text engine model is a trained AI-based model operable to generate new text based on a text prompt;
send a merchant user ID and the plurality of N subject lines to a trained inference model;
an online inference model server hosting the trained inference model, wherein the trained inference model was trained, for each subject line tested during training, on a data set of historical data corresponding to the merchant user ID and the plurality of features, and excluding data associated with other merchant user IDs, and wherein the trained inference model is operable to:
in response to the send, make a call to the inference data store based on the ID of the merchant user to obtain the precomputed values corresponding to the features and specific to the merchant user ID;
concatenate the retrieved precomputed values with a transformer embedding of the corresponding subject line to form a feature vector for each of the plurality of N subject lines specific to the merchant user ID; and
determine, by the trained inference model, a predicted score for each of the plurality of N subject lines based on the feature vector of the corresponding subject line;
and wherein the subject line management server is further configured to:
receive from the trained inference model the predicted score for each of the plurality of N subject lines;
rank the plurality of N subject lines based on the predicted scores;
reduce the N subject lines down to M subject lines by generating similarity scores between the transformer embeddings of each of the N subject lines and eliminating one or more subject lines based on a similarity with one or more other subject lines; and
communicate the M subject lines to the merchant server; and
wherein the merchant user server is configured to display the M subject lines to the merchant user.

20. (canceled)

21. The system of claim 19, further comprising an offline inference model server programmed to:
pull historical digital communication strategy data from one or more databases;
calculate the merchant user ID-specific precomputed values for the plurality of features based on the historical digital communication strategy data; and
populate the inference data store with the precomputed values by merchant user ID for use by the trained inference model.

22. The method of claim 1, further comprising performing, by an offline inference model server, the following:
pulling historical digital communication strategy data from one or more databases;
calculating the merchant user ID-specific precomputed values for the plurality of features based on the historical digital communication strategy data; and
populating the inference data store with the precomputed values by merchant user ID for use by the trained inference model.
